(19) United States
(12) Patent Application Publication
(10) Pub. No.: US 2007/0115108 A1
(43) Pub. Date: May 24, 2007

(54) Security system status notification device and method

(75) Inventors: Christopher D. Martin, Plainview, NY (US); Narine Boodoosingh, Ozone Park, NY (US)

Correspondence Address: Honeywell Law Department;Patent Services, 101 Columbia Road, AB-2, P.O. Box 2245, Morristown, NJ, 07962-2245, US

(73) Assignee: Honeywell International, Inc., Morristown, NJ (US)

(21) Appl. No.: 11/286,222

(22) Filed: Nov. 23, 2005

(51) Int. Cl. G08B 29/00

(52) U.S. Cl. 340/506

(57) ABSTRACT

A monitoring receiver for transmitting to a remote receiving device a notification message based upon an alert triggering event and a method of configuring the monitoring receiver to transmit the notification message are disclosed.

### BACKGROUND OF THE INVENTION

1. Field of the Invention

The invention relates generally to a security system that includes a central monitoring station containing a plurality of monitoring receivers that receive security and safety information from a plurality of local security systems located at different locations. More specifically, the invention relates to a monitoring receiver being capable of notifying at least one remote receiving device of the status of the monitoring receiver, wherein the status can be a problem with the monitoring receiver and the monitoring receiver can alert at least one remote receiver of the status wherever the device is located.

2. Background

Security systems, such as for homes and businesses, have become commonplace as people seek to protect themselves and their property. The security system typically includes a central monitoring station that is in communication with a plurality of local security systems that are located at a home or business.

The central monitoring station is staffed with operators to monitor incoming communications and to determine when one or more of the monitored local security systems communicate an alarm. Upon receipt of an alarm, alerts or an alarming event, an operator contacts emergency services such as fire or police personnel in the appropriate municipality by telephone to report the alarm.

In response to a received message, the central monitoring station processes the message and performs the necessary response. The messages from the respective security systems may include identifiers that identify the security systems.

The central monitoring station includes receivers and transmitters for communicating with different security systems via one or more networks. The receivers receive messages via a communication link from the local individual security systems. Each receiver is connected to an automation system. The automation system is typically an automation computer that is programmed with control and processing instructions. The receivers are connected to the automation computer by an automation computer port.

Additionally, each receiver is connected to a printer such that the data that the receiver receives can be printed for the operator. Each receiver is connected to its printer via a printer port and a printer cable.

A monitoring receiver's proper functionality is essential to a security system. If a monitoring receiver has a problem and is unable to receiver an alert message from the plurality of local security systems, for even a second, a fire, burglary and emergency condition can go undetected. Therefore, the problem or error must be fixed quickly.

Therefore, there is a need for a central monitoring station to have a means that allows an operator, manager, maintenance person or other interested parties to be notified of any problem with any of the monitoring receivers located within the central monitoring stations even when the above-identified persons are not located at the central monitoring station.

Currently, when a central monitoring receiver has a problem, the receiver generates an error message and transmits the error to the automation system and at the same time displays the error message on the display or prints it to a printer. Therefore, the operator must monitor the automation system or be within viewing distance of the display to be aware of the problem. However, if a maintenance person or a manager of the central monitoring station is off premises, the person may not be aware of the problem, and the error could remain unfixed.

### BRIEF SUMMARY OF THE INVENTION

The present invention describes a solution that allows the monitoring receiver to be able to send instant notifications to a plurality of parties of an internal problem or potential problem, whether the parties are on or off the premises allowing for corrective actions to be taken immediately.

A monitoring receiver for notifying at least one person of an alert triggering event at a central monitoring receiver is provided. The monitoring receiver comprises a detecting means for detecting the alert triggering event at the central monitoring receiver, a determining means for determining a type of the alert triggering event by reading out an error code from a memory section and for determining if at least one contact identifier is assigned to the type of alert triggering event for receiving a notification message, a message generating means for generating a notification message based upon the type of the alert triggering event and a transmitting means for transmitting the notification message to a remote receiving device which corresponds to the contact identifier. The notification message can be received by at least one person regardless of the person's location.

Also disclosed is a monitoring receiver capable of transmitting a notification message to at least one operator of an alert triggering event at the central monitoring receiver. The monitoring receiver comprises a programming means for programming at least one contact identifier into the central monitoring receiver. The monitoring receiver further comprises a determining means for determining if a notification message will be generated for the alert triggering event, an assignment means for assigning at least one contact identifier for the alert triggering event if it is determined that the notification message will be generated for the alert triggering event, and a programming means for programming a customized outgoing error message and a message generating means for configuring the customized error message based upon a transmission type and contact identifier. The contact identifier corresponds to a remote receiving device. The central monitoring receiver is configured to be capable of transmitting the customized error message to the remote receiving device based upon the transmission type.

The transmission type can be any communication method including an email message and a text message.

Further disclosed is a method of notifying at least one person of an alert triggering event at a central monitoring receiver. The method includes detecting the alert triggering event at the central monitoring receiver, determining a type of alert triggering event, determining if at least one contact identifier is assigned to the type of alert triggering event for receiving an outgoing notification message, generating an outgoing notification message based upon the type of alert triggering event, and transmitting the outgoing notification message to a remote receiving device that corresponds to the contact identifier.

The outgoing notification message can be received by at least one person regardless of their location.

The disclosed method can further include the steps of determining if a specific schedule and/or priority for transmitting the outgoing notification message have been programmed and transmitting the outgoing notification message based upon the determination.

Also disclosed is a method of configuring a central monitoring receiver to generate a notification message to at least one remote receiving device of an alert triggering event at the central monitoring receiver. The method comprises a step of programming at least one contact identifier into the central monitoring receiver. The method further comprises, for each type of alert triggering event, the steps of determining if a notification message will be generated for the alert triggering event, assigning at least one contact identifier to the alert triggering event, if it is determined that the outgoing notification message will be generated for the alert triggering event, programming a customized error message and configuring the customized error message based upon a transmission type and contact identifier. The contact identifier corresponds to a remote receiving device. The central monitoring receiver is configured to be capable of transmitting the customized error message to at least one remote receiving device based upon the transmission type.

A computer program that allows the monitoring receiver to perform the described method steps is also disclosed. This program can be pre-installed in the monitoring receiver or remotely downloaded.

### BRIEF DESCRIPTION OF THE DRAWINGS

These and other features, benefits and advantages of the present invention will become apparent by reference to the following text figures, with like reference numbers referring to like structures across the views, wherein:

FIG. 1 illustrates a central monitoring station having a plurality of monitoring receivers.

FIG. 2 illustrates a monitoring receiver according to the invention.

FIG. 3 illustrates a method of configuring the monitoring receiver according to an embodiment of the invention.

FIG. 4 illustrates an example of a method for configuring the monitoring receiver to transmit a customized outgoing error message to a remote receiving device based upon a transmission type where the transmission type is an e-mail.

FIG. 5 illustrates a method of creating a Message Schedule and Priority Table according to an embodiment of the invention.

### DETAILED DESCRIPTION OF THE INVENTION

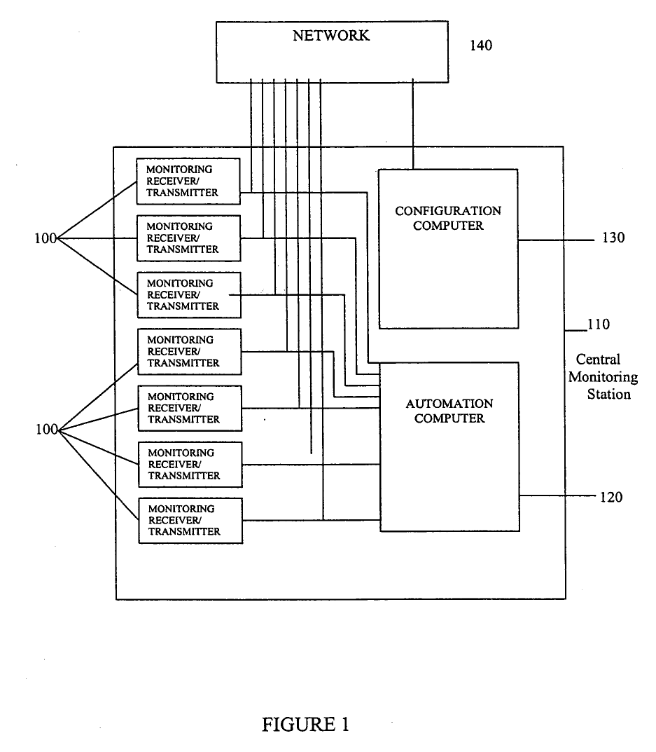

FIG. 1 illustrates a central monitoring station 110. The central monitoring station 110 can include a configuration computer 130 that is programmed to upload and download local installed security system configurations. The central monitoring station 110 is typically provided at a staffed facility that is remote from the local installed security systems, which it serves. The staff at the central monitoring station 110 may monitor the alarm status of the different local security systems and take appropriate actions such as notifying emergency personnel when an alarm is tripped.

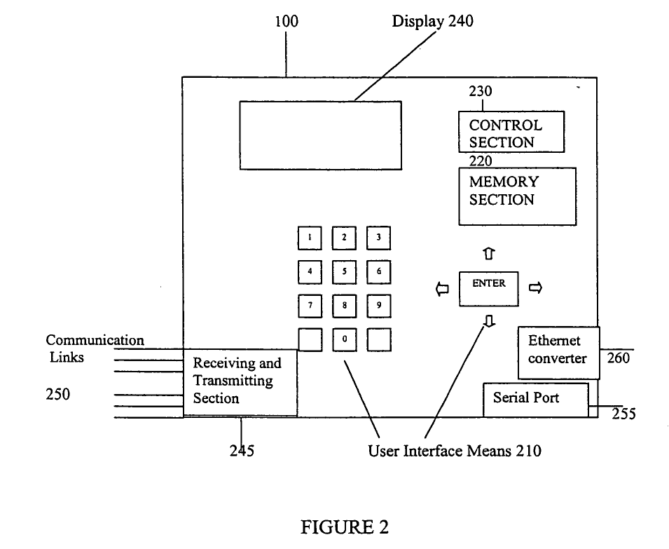

The central monitoring station 110 is connected to the local installed security system via a network 140 and a communication link 250, as depicted in FIG. 1 and FIG. 2. The communication link 250 can be any means that allows for bi-directional transmission of data. The communication link 250 can include essentially any type of communication path or paths, including a telephone link, to communicate with the local security system. Alternatively, the communication link 250 can include a modem. The network 140 includes a computer network such as the Internet. For instance, the local installed security systems may use a communications protocol such as TCP/IP to communicate with the central monitoring station. Other communication paths such as satellite or RF radio paths, including, e.g., those using GSM or CDMA techniques may also be used. Moreover, the different local installed security systems may use different communication paths, and upstream communications to the central monitoring station 110 may be on different paths than downstream communication from the central monitoring station 110. In addition, the different communication paths may be attempted serially until a successful communication is made.

The central monitoring station 110 includes a plurality of receivers and transmitters 100 for communicating with different local installed security systems via one or more networks. The plurality of receivers and transmitters 100 are connected to at least one automation computer 120. Each of the plurality of receivers 100 has its own communication path or a primary path to the automation computer 120. The receivers 100 are connected to the automation computer 120 via an automation port.

The automation computer 120 collects and processes signals received by the receiver from the local installed security system. For example, if a motion sensor connected to a control panel at a local installed security system is tripped; the control panel will send a signal via a communication link 250 and network 140 to one of a plurality of receivers 100. This alarm signal is then sent to the automation computer 120 for processing. The operator at the central monitoring station 110 monitors the automation computer 120 and coordinates the proper response.

The configuration computer 130 is programmed with software to achieve the desired functionality including instructing the plurality of receivers 100 to recover periodically updated information and other data from the local installed security systems and to initiate transmissions to the local installed security systems.

FIG. 2 illustrates a monitoring receiver 100 according to an illustrative embodiment of the invention. Each monitoring receiver 100 includes a receiving and transmitting section 245, a display 240, a user interface means 210, a memory section 220, a control section 230, a plurality of communication links 250, and at least one serial port 255. The monitoring receiver 100 will also include an Ethernet converter 260 coupled to the serial port 255 to enable the monitoring receiver 100 to send an email. This Ethernet converter 260 or connection can also be an internal connection built into the monitoring receiver 100.

The receiving and transmitting section 245 typically includes a plurality of input ports that allows a connection to a plurality of local security systems over the plurality of communication links 250. The plurality of communication links 250 enables the local security systems to report an alarm to the central monitoring station. Typically, the plurality of communication links 250 are telephone links, however, the monitoring receiver 100 is capable of using any available communication links 250, such as DSL, or cable modem, long range radio, cellular, Internet or Intranet. The communication links 250 allow the central monitoring station 110 to monitor, in real time, the status of each of the local security systems that are connected to a monitoring receiver 100 at the central monitoring station.

The control section 230 controls the overall processing of all user-input commands and other pre-programmed instructions stored in the memory section 220. The display 240 displays various menu options, and user updated input commands. The memory section 220 is used for storing pre-programmed instructions, software updates containing new control information and local security system identifiers.

The user interface means 210 can be of any known form such as an alphanumeric keypad, a touch panel, a keyboard, or a remote computer that functions to input data.

The serial port 255 allows the monitoring receiver 100 to receive software updates via a hardwired connection with a computer or a network connection to a security system configuration computer 130.

According to an embodiment of the invention, each receiver will contain software that allows the receiver to recognize an alert triggering event, determine the type of alerting triggering event, match the alert triggering event with a predefined error code that is installed in the central monitoring receiver 100, generate an outgoing notification message containing this predefined error code, and transmit the outgoing notification message to at least one person.

Software updates containing program code for configuring the monitoring receiver to perform the desired functions can be downloaded via the serial port 255 from a computer that is connected to the central monitoring receiver 100. It is further contemplated that the software updates can be downloaded from the security system receiver configuration computer 130. The configuration computer 130 is typically located at the central monitoring station 110. Using a VPN it could potentially be located anywhere. Alternatively, the configuration computer 130 can be located at a remote location. For example, the configuration computer can be located at a remote office and be accessed by the monitoring receiver 100 via a network connection. The monitoring receiver 100 is connected to the security system receiver configuration computer 130 by a connection link or Internet. It is further envisioned that the software can be preinstalled into the monitoring receiver 100 during manufacture.

Once the software in installed, the operator can input control instructions into the monitoring receiver 100 such that the monitoring receiver 100 can perform the desired function. This can be performed by manually inputting the configurations into the receiver 100 using the user interface means 210. The monitoring receiver 100 can also be configured from a remote location by downloading the configurations from the configuration computer 130. All of the configurations will be stored in the receiver's memory section 220.

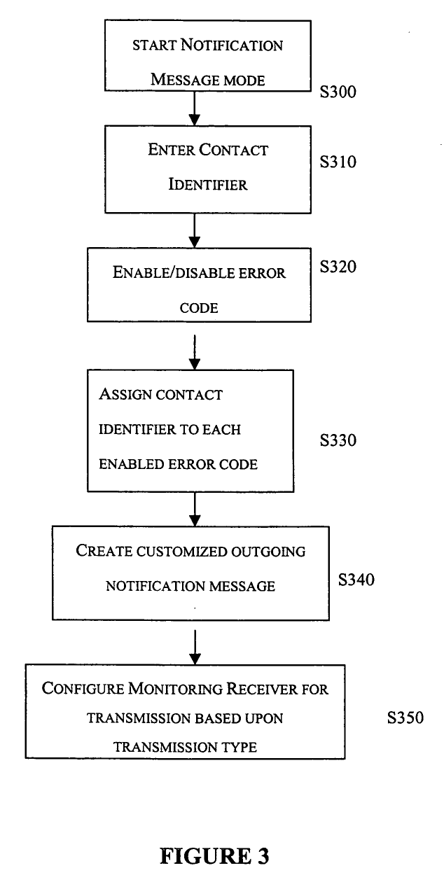

FIG. 3 illustrates the method of configuring the monitoring receiver 100 to detect an error, determine the type of error, generate an error message, and transmit the message to a remote receiving device.

To manually configure the central monitoring receiver 100, the central monitoring station operator will use the user interface means 210 to navigate through a menu tree. The receiver has several menu options listed in the general options menu.

The operator will select notification message mode from the general options, at step S300. For example, the option menu would read “notification” or “error alert” or “remote alert”. To select this option the operator will depress the enter button on the user interface means 210.

The monitoring receiver 100 will then prompt the operator to enter a contact identifier for at least one person that the operator would like the monitoring receiver 100 to contact or notify, if there is an alert triggering event (step S310). A contact identifier can be an email address, a pager number or a cell phone number. However, a contact identifier is not limited to the aforementioned list. This list is provided for exemplary purposes. The contact identifier allows the monitoring receiver 100 to contact a person at a remote location via a remote receiving device.

The contact identifier will be entered using the user interface means 210 and the contact identifier will be displayed on a display 240. Alternatively, this information can be programmed from a remote location using configuration software installed in the receiver. The monitoring receiver 100 can prompt the central monitoring station operator to confirm the identifier based upon viewing it on the display 240. The operator will have to use the user interface means 210 to confirm the contact identifier. The operator can enter a plurality of contact identifiers into the monitoring receiver 100.

Once all of the contact identifiers have been entered and confirmed, the operator will then determine which one of a plurality of internal error codes the operator would like to enable the receiver to send a notification message, at step S320. The monitoring receiver 100 contains a plurality of predefined internal error codes that correspond to an alert triggering event.

Specifically, the operator can determine that all or only a subset of the plurality of error codes are to result in a notification message being sent to a remote receiving device. For example, the operator can choose that a notification is to be sent only when the error code relates to or directly involves a monitoring receiver's 100 problem of some kind or an alert triggering event, as opposed to an error code that relates to a problem of some kind or an alert triggering event at a local security system.

The operator will create an Error Code Table which will include both enabling and disabling parameters such that the operator can individually select each error code for either generating a notification or not. The Error Code Table will be stored in the monitoring receiver's memory section 220. The Error Code Table will be displayed on the display 240 of the monitoring receiver 100 during this initial configuration stage. This will allow the operator to use the user interface means 210 to enable or disable a notification for each error code, enter a desired notification state (enable/disable), and save the state in memory. The following is an example of a portion of the Error Code Table:

| | |
|---|---|
| [Enable] [Disable] | Line Card Expander Trouble |
| [Enable] [Disable] | AlarmNet Expander Trouble |
| [Enable] [Disable] | Automation Failure |
| [Enable] [Disable] | Printer Failure |
| [Enable] [Disable] | Line Fault Error |
| [Enable] [Disable] | Message Queue Warning, Full |

This table is only provided as an example of the error codes; the invention is not limited to this terminology or error type.

Once the operator has determined which of the plurality of error codes will generate a notification message to a remote receiving device, the operator must then associate or assign at least one of the programmed contact identifiers with the enabled error codes, at step S330. This allows the operator to select where and to whom the notification message will be sent for each error code. Specifically, a contact identifier represents the contact information for a specific person or persons via a specified transmission means. The contact identifier, for example, can be a home or work email address, a cell phone number or a pager number.

The contact identifier can correspond to any person affiliated with the central monitoring station, such as a central station manager, a plurality of maintenance employees, or an owner of the central station facility, etc. For example, the contact identifier can be a home email address for the owner of the central monitoring station. In another example, the contact identifier can be an email address or telephone number of a homeowner or business that reports into the central monitoring station 110 and, more particularly, to the monitoring receiver 100, such an a subscriber.

An operator can assign a single contact identifier or a plurality of contact identifiers to each selected or enabled error code. This allows for efficient management of an error or problem with the monitoring receiver 100. For example, if a central monitoring station 110 has multiple employees in a maintenance department, one employee might be specifically responsible for a first error code and a second employee might be responsible for a second error code. The operator can assign the first employee as the primary contact for the first error code and the second employee as the primary contact for the second error code. Additionally, the operator can select as a secondary contact a central monitoring station manager.

In order to select a specific person to whom the notification is to be sent, the operator will match or assign the corresponding contact identifier with the specific error code using the Error Code Table. For each enabled error code, the operator will select at least one of the previously entered contact identifiers (at step S310) using the user interface means 210. This process will be repeated for all of the desired contact person's locations. For example, the operator can choose to send a notification message to the central station manager of “line card expander trouble”. To accomplish this, the operator will have to match and assign the contact identifier for the central station manager with the error code for “line card expander trouble”.

After all of the desired enabled error codes have been assigned or matched with a contact identifier, the operator can customize an outgoing error message, at step S340. The outgoing error message includes two portions, a header portion and a message portion.

The customized outgoing error message can include a default message header with a default error message, a customized message header, and a customized error message or any combination thereof.

One customized outgoing error message will be assigned to correspond with each enabled error code where an enabled error code corresponds with an alert triggering event. An alert triggering event is any potential error or problem with the central monitoring receiver 100.

The display 240 will list the plurality of predefined internal error codes in the form of the Error Code Table. To assign or create a customized outgoing error message for each error code, the operator will configure or select one error code at a time and create a customized outgoing error message for each error code. The operator will enter the customized outgoing error message using the user interface means 210. Once the customized outgoing error message is entered into the receiver, the message and assignment to a corresponding error code will be stored in the memory section 220.

In one embodiment, this process is repeated for each error code. However, in another embodiment, the operator can configure and assign a customized outgoing error message for the most common error codes and use a default error message as the remaining error codes. In another embodiment all of the outgoing error messages can be a default outgoing error message.

While this method has been described as having each step of the method being performed sequentially, it is within the scope of the invention to perform several of the steps simultaneously or in a different order.

For example, Step S350 can be performed at the same time as entering the contact information and enabling the reports. In other words, the step of enabling/disabling an error code can be done for each contact identifier, thus in essence eliminating Step 330 as a separate step.

Additionally, the order of performing the steps can be changed. For example, the operator can program an alert schedule for each contact identifier, as will be described later, prior to enabling or disabling the error codes. This will allow the schedule to be based upon whether or not either or both the person contacted and/or the nature of the error code.

Furthermore, the step of customizing the outgoing error message (Step S340) only needs to be performed once, during the initialization.

Prior to being able to send a notification message, the operator must configure the monitoring receiver 100 to be able to transmit the customized outgoing error message to a remote receiving device based upon a transmission type, this process only has to be performed at an initialized stage. The monitoring receiver 100 is capable of transmission to the receiving device using a plurality of methods, for example, but not limited to, email over a network, and text message to a pager or cell phone over a telephone network.

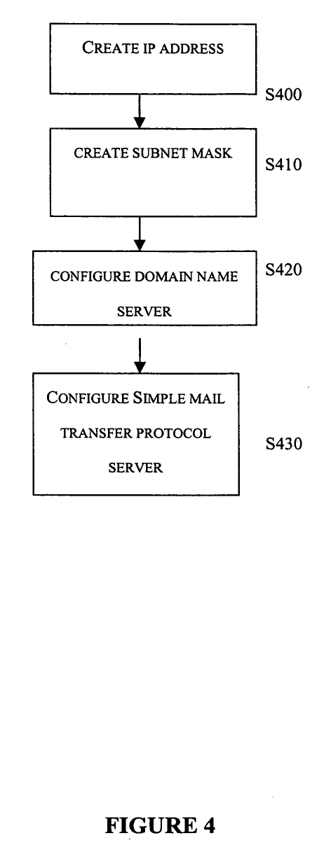

In an illustrative embodiment, the method of transmission is an email over a communication network such as the Internet. Accordingly, the operator must configure the monitoring receiver 100 to be able to send an email over the Internet. FIG. 4 illustrates a method for configuring the monitoring receiver 100 to be capable of sending an email message.

In order to send an email, a sending device, such as the monitoring receiver 100 must have an IP address. Such an IP address is automatically generated by a Dynamic Host Configuration Protocol (DHCP). If not, the operator will have to manually enter the IP address using the user interface means 210, at step S400. Alternatively, the IP address can be received from the configuration computer 130.

Once the IP address has been entered and stored in the memory section 220, a SubNet Mask must be entered, at step S410. The SubNet Mask must match the mask for a local network. Once again, such a value is automatically generated by a Dynamic Host Configuration Protocol (DHCP). If not, the operator will have to manually enter the SubNet Mask using the user interface means 210. Alternatively, the SubNet Mask can be received from the configuration computer 130.

Next, a Domain Name Server (DNS) is configured to convert an email contact identifier into its corresponding IP address, at step S420. Domain name servers translate domain names to IP addresses. Depending on the configuration of the receiver, Step S420 might not be needed.

Next, a Simple Mail Transfer Protocol Server (SMTP) is configured to interact with a plurality of domain names, at step S430. An SMTP Server divides a “to” address such as mail.Honeywell.com and breaks it into two parts: the recipient name and the domain name. The SMTP allows email between multiple servers in different domains, i.e., different domain names.

Depending on the type of email server, two additional steps may be needed. An operator's email account and password may need to be entered prior to being able to generate an email message. Typically, an email account name and password is used for security purposes.

In another embodiment of the invention, the operator also has the option of generating a Message Schedule and-Priority Table that can be programmed into the monitoring receiver 100. This Message Schedule and Priority Table can include time, destination, communication formats, and priority information. However, the Message Schedule and Priority Table are not limited to the above-identified examples.

The Message Schedule and Priority Table will be used by the monitoring receiver 100 to determine where, when and how to send a notification message to at least one remote receiving device. Specifically, the table will allow the operator to select a particular contact identifier and receiving device to be a notified depending on the time of day. Thus, the operator can account for a person's availability, sleep schedule or a plurality of employees work shifts or schedules.

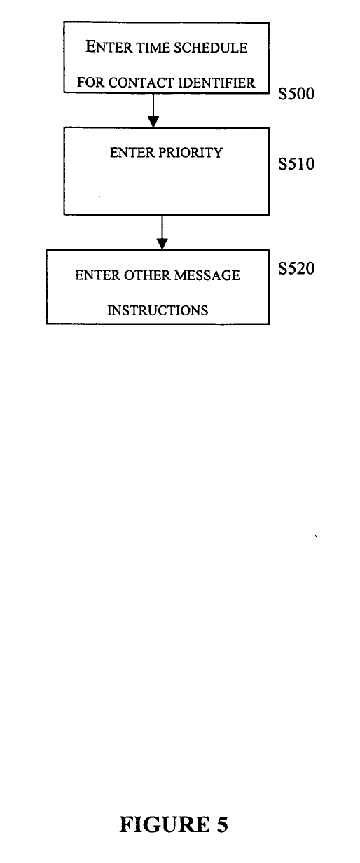

In this embodiment, the Message Schedule and Priority Table will be created during the step of entering at least one contact identifier into the monitoring receiver 100. FIG. 5 illustrates the method of creating and storing a plurality of message instructions into the monitoring receiver 100 as the Message Schedule and Priority Table. After the contact identifier is entered, the monitoring receiver 100 will prompt the operator to enter a specific time of day that the contact identifier is valid, i.e., time which the monitoring receiver 100 can contact the corresponding receiving device, at step S500. For example, a central monitoring station manager can have two contact identifiers, both being email addresses where a first email address is a work email address and the second is a home email address. The operator can choose to send the outgoing notification message to the manager's work email address during business hours and to the home email address during non-business hours.

Accordingly, the operator will enter a specific time of the day for each contact identifier using the user interface means 210.

Additionally, the operator can choose a specific priority order for sending the outgoing notification message, at step 510. For example, the operator can decide that the primary notification should go to a maintenance employee while a secondary notification should go to the central monitoring station manager. Alternatively, the monitoring receiver 100 can be configured to send a secondary notification to a different contact identifier after a predetermined time period where the alert triggering event has not been remedied and error code reset. Additionally, the monitoring receiver 100 can be configured such that if the transmission fails, the monitoring receiver 100 can automatically re-transmit the outgoing notification message to a secondary remote receiving device, using a secondary contact identifier.

Priority information and parameters can also be entered into the Message Schedule and Priority Table while the operator is entering the contact identifiers into the monitoring receiver 100. The monitoring receiver 100 will prompt the operator to enter a priority of each entered contact identifier (step S510).

Additionally, the Message Schedule and Priority Table can include information such as communication formats, i.e., email, text message, phone message and destinations, such as home computers, cell phones, other PDA types, etc. This information would be entered at step 520.

Next, the invention will be described as a sequence of steps to generate an outgoing notification message once the monitoring receiver 100 has been configured in accordance with any of the above-identified processes.

The first step is the detection of an alert triggering event or error. Once an alert triggering event or error is detected, the second step is that the monitoring receiver 100 will then determine the type of the alert triggering event. This is done by matching the error or alert triggering event as with a predefined error code that was previously stored in the memory section 220 of the monitoring receiver 100 in the form of the Error Code Table.

There are two main categories of errors: line card communication errors and system event errors. Line card communication errors relate specifically to how the receiver communicates to an incoming call. A system event error relates specifically to the system and the performance of its corresponding peripheral devices, such as the automation system, software, printers, etc.

In a third step, the monitoring receiver 100 will select the corresponding error code from the Error Code Table. The error code will be displayed on the display 240 of the monitoring receiver 100 as well as being sent to both the automation computer 120 and the printer.

Next, in a fourth step, the monitoring receiver 100 will determine where, how and to whom to send an outgoing error message based upon a previously programmed instruction. As described above, the operator matches or assigns the corresponding contact identifier with the specific error code using the Error Code Table. Using the example from above where the error code was a Line Card Expander Trouble, the central station operator would receive an error notification based upon the previously programmed instruction using the communication method that was also previously programmed.

In another embodiment, the monitoring receiver 100 will perform an additional step of determining whether the operator provided additional messaging instructions in the Message Schedule and Priority Table.

During the next step, the monitoring receiver 100 will generate an outgoing notification message based upon both the detected alert triggering event and the type of transmission selected. The step includes selecting, from the memory section, a pre-stored notification message for transmission. The operator customized this outgoing notification message during the configuration process.

Once the contact identifier has been selected and the outgoing message has been generated, the monitoring receiver 100 will then transmit the outgoing notification to a remote receiving device, which corresponds to the contact identifier using a communication means, the next step.

The monitoring receiver 100 will determine the method of transmission based upon the contact identifier. For example, if the contact identifier is an email address, the monitoring receiver 100 will transmit an email, using the Internet to the remote receiver device.

The monitoring receiver 100 will transmit the email message using its serial port 255 and an external Ethernet connection or converter 260. For example, the serial port 255 can be a RS232. Alternatively, the monitoring receiver 100 will contain an internal Ethernet converter and the email will be sent using this internal Ethernet device.

In another embodiment the contact identifier can be a telephone or pager number. The monitoring receiver 100 will then transmit the outgoing notification message as a text message to the pager or telephone using one of the existing and available line cards.

In yet another embodiment, the monitoring receiver 100 can transmit a prerecorded voice message to a cell phone or telephone.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A method of transmitting a notification message of an alert triggering event at a central monitoring receiver, the method comprising the steps of:
(a) detecting the alert triggering event at the central monitoring receiver;
(b) determining a type of said alert triggering event;
(c) determining if at least one contact identifier is assigned to said type of alert triggering event for receiving the notification message;
(d) generating the notification message based upon said type of said alert triggering event; and
(e) transmitting said notification message using a communication means to at least one remote receiving device which corresponds to said at least one contact identifier.

2. The method of claim 1, wherein step (d) further comprises the step of encoding said notification message based upon a predefined error code that corresponds to said alert triggering event.

3. The method of claim 2, wherein the communication means is determined by said contact identifier.

4. The method of claim 1, wherein step (e) includes the step of pre-storing an email message that contains said notification message.

5. The method of claim 4, wherein said email message is transmitted to at least one programmed email address using said communication means.

6. The method of claim 3, wherein step (e) includes generating a text message that contains said notification message.

7. The method of claim 1, wherein step (c) further comprises determining if at least one messaging instruction has been programmed for said contact identifier or said type of alert triggering event.

8. The method of claim 7, wherein said at least one message instruction is a time of availability of said contact identifier.

9. The method of claim 8, wherein said at least one message instruction is a priority order for sending said notification message.

10. The method of claim 9, wherein said notification message is transmitted based upon said priority order.

11. The method of claim 1, wherein said notification message is re-transmitted to said remote receiving device after a predetermined period of time if said alert triggering event is maintained.

12. A method of configuring a central monitoring receiver to generate a notification message to at least one remote receiving device of an alert triggering event at said central monitoring receiver, the method comprising:
programming at least one contact identifier into said central monitoring receiver;
for each type of alert triggering event:
determining if the notification message will be generated for said alert triggering event;
assigning at least one contact identifier to said alert triggering event, if it is determined that said outgoing notification message will be generated for said alert triggering event, where said contact identifier corresponds to a remote receiving device;
programming a customized error message; and
configuring said customized error message based upon a transmission type and contact identifier,
wherein said central monitoring receiver is configured to be capable of transmitting said customized error message to said at least one remote receiving device based upon said transmission type.

13. The method of claim 12, wherein the step of programming at least one contact identifier further comprises programming at least one message instruction into said monitoring receiver and associating said monitoring instruction with said contact identifier or alert triggering event.

14. The method of claim 12, wherein said customized notification message includes a header and a customized error message.

15. The method of claim 12, wherein said transmission type is an email message.

16. The method of claim 12, further comprising the step of programming the monitoring receiver to re-transmit said customized notification message after a predetermined time period where said alert triggering event is maintained.

17. The method of claim 13, wherein said at least one message instruction is a priority order for transmitting said customized notification message.

18. The method of claim 13, wherein said at least one message instruction is a schedule for transmitting said customized notification message based upon an availability of said contact identifier and remote receiving device.

19. A monitoring receiver for notifying at least one person of an alert triggering event at a central monitoring receiver, the monitoring receiver comprising:
detecting means for detecting the alert triggering event at the central monitoring receiver;
determining means for determining a type of said alert triggering event by reading out an error code from a memory section and for determining if at least one contact identifier is assigned to said type of alert triggering event for receiving a notification message;
message generating means for generating an notification message based upon said type of said alert triggering event; and
transmitting means for transmitting said notification message to a remote receiving device which corresponds to said contact identifier,
wherein said notification message can be received by said at least one person whether said person is located at a central monitoring station or not.

20. The monitoring receiver according to claim 19, wherein said transmitting means includes a serial port and an Ethernet converter.

21. A computer program product comprising a computer usable storage medium having computer-readable program code embodied in the medium for controlling a processor in a monitoring receiver, the computer-readable program code comprising:
program code for detecting the alert triggering event at the central monitoring receiver;
program code for determining a type of said alert triggering event by reading out an error code from a memory section and for determining if at least one contact identifier is assigned to said type of alert triggering event for receiving an notification message;
program code for generating the notification message based upon said type of said alert triggering event; and
program code for transmitting said notification message using a communication means to an remote receiving device which corresponds to said contact identifier.

22. A monitoring receiver capable of transmitting a notification message to at least one operator of an alert triggering event at said central monitoring receiver, the monitoring receiver comprising:
a programming means for programming at least one contact identifier into said central monitoring receiver;
a determining means for determining if the notification message will be generated for said alert triggering event;
an assignment means for assigning at least one contact identifier for said alert triggering event if it is determined that said notification message will be generated for said alert triggering event, where said contact identifier corresponds to a remote receiving device;
a programming means for programming a customized outgoing error message; and
a message generating means for configuring said customized error message based upon a transmission type and contact identifier,
wherein said central monitoring receiver is configured to be capable of transmitting said customized error message to said remote receiving device based upon said transmission type.
